(19) United States
(12) Patent Application Publication
(10) Pub. No.: US 2026/0097605 A1
(43) Pub. Date: Apr. 9, 2026

(54) System and Method for Creating and Maintaining a Fellowship Journal

(71) Applicants: Cynthia Crane, Huntington Beach, CA (US); Tiffany Liebeck, Huntington Beach, CA (US)

(72) Inventors: Cynthia Crane, Huntington Beach, CA (US); Tiffany Liebeck, Huntington Beach, CA (US)

(73) Assignee: Uncomplicated Faith LLC, Huntington Beach, CA (US)

(21) Appl. No.: 18/910,280

(22) Filed: Oct. 9, 2024

(51) Int. Cl. B42D 1/10

(52) U.S. Cl. CPC B42D 1/10

(57) ABSTRACT

A system and method for creating and preserving a fellowship journal through a bound journal book and specially sized adhesive-backed stationery sheets. Contributors can write personalized messages on the adhesive-backed sheets, which the user permanently affixes to the journal's pages, ensuring each message becomes a lasting part of the journal. The invention also includes kits containing the journal, adhesive sheets, and instructions, enabling users to easily create and maintain a personal or group fellowship journal. Unlike traditional journaling methods that lack provisions for external contributions, this invention offers a durable, customizable way to collect and preserve messages from multiple individuals in a single bound volume. The invention's flexibility supports both individual users and groups, allowing each participant to document and receive messages, creating a collective record of shared experiences.

### FIELD OF THE INVENTION

The present application relates to a physical-media-based journaling system designed for creating and preserving personalized messages from multiple contributors. Specifically, the system provides a bound journal book and adhesive-backed stationery sheets that, once applied, enable messages from contributors to become a permanent part of a fellowship journal. Embodiments of the invention also encompass kits that facilitate both individual and group journaling experiences.

### BACKGROUND

The digital age has shifted much of personal communication online, yet there remains a strong desire for tangible, meaningful ways to capture and preserve messages from friends, family, and colleagues. Traditional journaling methods generally facilitate individual reflections but lack a cohesive system for integrating permanent, lasting contributions from multiple individuals. Similarly, digital and online platforms allow for the collection of messages but do not provide the same physical or sentimental value as a tangible book with handwritten messages.

The present invention addresses this need by providing a system and method that allows messages from friends, family, or colleagues to be recorded on adhesive-backed sheets and permanently integrated within a bound journal book. This system creates a fellowship journal that becomes a lasting physical memento for the user.

### SUMMARY OF THE INVENTION

This invention comprises a bound journal book system with adhesive-backed stationery sheets sized to fit within the pages of the journal. Contributors can write messages to the journal user on these sheets, which the journal user can then permanently adhere to the journal pages. The messages can range from personal notes, reflections, advice, wisdom, prayers, drawings or any content that they wish to share with the journal user, and the journal user can write their own thoughts in adjacent pages within the journal. This method allows for a diverse range of inputs, capturing different voices and perspectives, and enriching the journal with a multitude of insights and emotions. The invention also includes kits with the bound journal, adhesive-backed sheets, and instructions, enabling users to create and maintain a fellowship journal, either as individuals or as part of a group.

The kits provide all the components necessary for creating a fellowship journal, ensuring that users have a simple, meaningful way to collect messages and make them a permanent part of a physical record.

### BRIEF DESCRIPTION OF THE DRAWINGS

FIG. 1 is an illustration showing the bound journal book in the open and closed conditions, as well as a plurality of the adhesive-backed stationery sheets.

FIG. 2a is an illustration of the process by which messages written on the adhesive-backed stationery sheets are placed into the bound journal book.

FIG. 2b is an illustration of the bound journal book with a message written on an adhesive-backed stationery sheet secured to a page.

FIG. 3 is a flowchart illustrating the flow of messages between the Individual Contributors and a single Journal User.

FIG. 4 is a flowchart illustrating the flow of messages between the Individual Contributors and multiple Journal Users in a group setting.

FIG. 5 is an illustration of the kit described in claim 3.

FIG. 6 is an illustration of the kit described in claim 4.

### DETAILED DESCRIPTION OF THE INVENTION

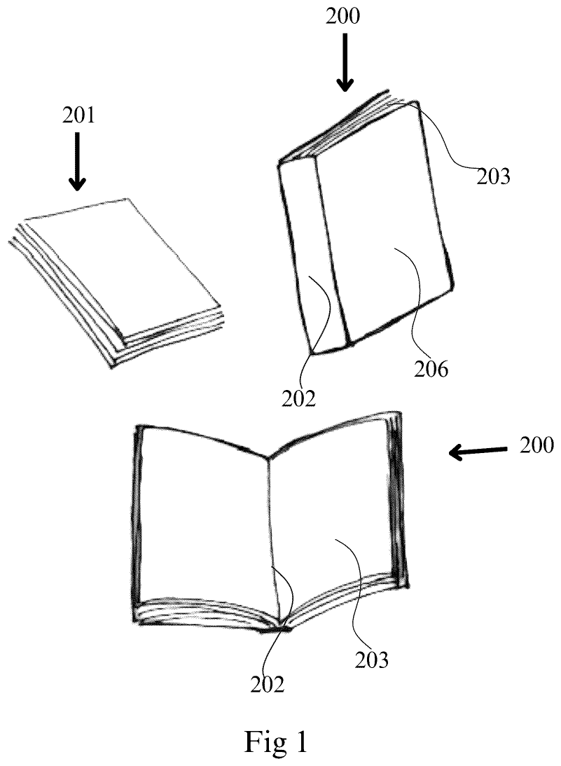

The preferred embodiment comprises at least a bound journal book 200 and a plurality of adhesive-backed stationery sheets 201, as illustrated in FIG. 1. In a preferred embodiment the journal book 200 contains a plurality of pages 203 which may be blank or ruled, bound 202 within a durable cover 206. Each page provides sufficient area to accommodate one or more adhesive-backed sheets 201, 204 designed to fit entirely within the page 203 boundaries. The pages 203 are fixed within the journal book 200 and the adhesive-backed sheets 201, 204 are designed to adhere permanently to the pages 203, ensuring messages 204 remain intact within the journal 200.

In a preferred embodiment the journal book 200 may vary in size and page 203 count, depending on user preference. Its pages 203 may be blank, ruled, or decorated. It may have hard or soft covers 206, with or without decoration, and can be bound 202 in any effective method, such as hardbound, softbound, or spiral bound, among others. This flexibility in the embodiment of the journal book 200 accommodates various aesthetic and practical preferences, providing the user with a journal book 200 that meets their individual or group needs.

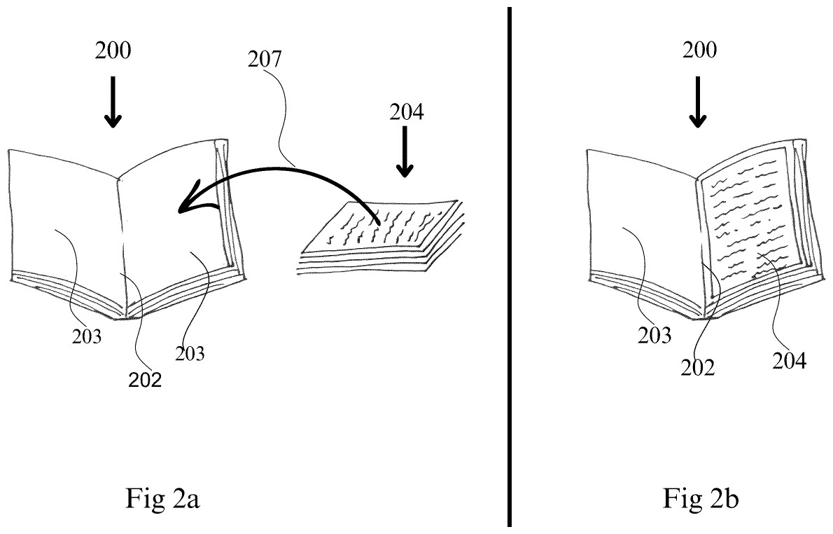

In a preferred embodiment the adhesive-backed sheets 201 are sized to fit within the page 203 bounds of the journal book 200, leaving a small margin for a neat appearance. FIGS. 2a and 2b illustrate the placement of messages The preferred embodiment of the interface between the journal book page 203 and the adhesive-backed sheet 201, 204 yields a gap of approximately ⅛″ between the edge of the sheet 201, 204 and the edge of the journal page 203 when affixed. This small gap ensures that each sheet 201 fits completely within the journal book's pages 203, providing a border around the message 204 and ensuring that no adhesive remains exposed once the message 204 is affixed in the journal book 200.

In an alternative embodiment, the adhesive-backed sheets 201, 204 can be smaller in size, such that they cover less than a full page 203. The important constraint is that the sheets 201, 204 do not exceed the page dimensions of the journal book 200 in any direction. This flexibility allows for various arrangements within the journal 200, such as centering the sheet 204 on the page or arranging multiple sheets 204 on a single page 203. The adhesive is designed for permanence once applied, ensuring each sheet 204 remains securely in place within the journal.

The preferred embodiment of the method of creating and maintaining a fellowship journal uses the system comprising in a preferred embodiment the bound journal book 200 and the adhesive-backed stationery sheets 201 in conjunction with several key steps described hereinbelow.

In a preferred embodiment the bound journal book 200 is provided to the journal user. Provision of the bound journal book 200 to the user may be the result of the journal user purchasing it or it may be received by the journal user as a gift.

One or more adhesive-backed stationery sheets 201 are distributed by to one or more friends, family, colleagues or other persons who wish to write messages 204 to the journal user. The people who create and write messages 204 to journal users are known as ‘contributing individuals.’ Although it is commonly the case that the journal user and the contributing individuals are known to one another and are commonly family, friends, or colleagues, the preferred embodiment of the claimed method does not require that the journal user and the contributing individuals know one another prior to beginning the fellowship journaling process.

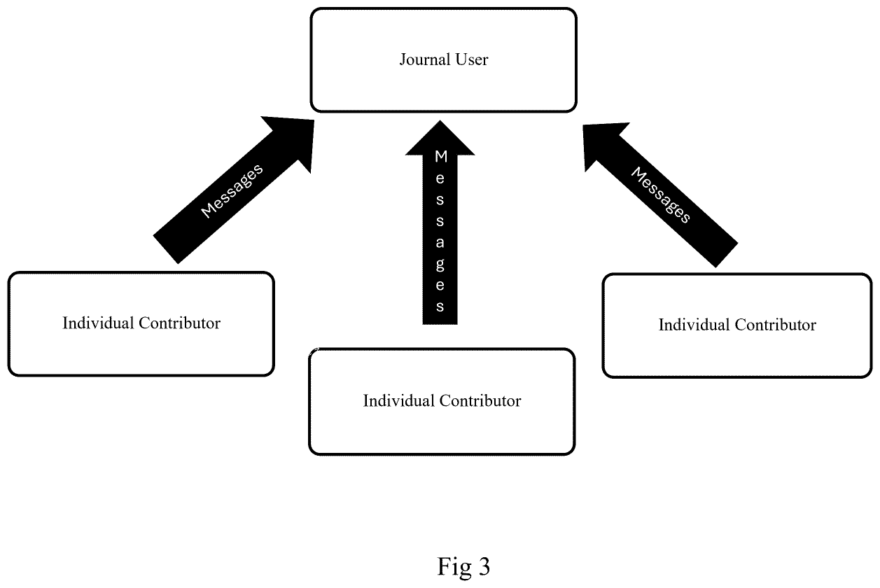

After receiving one or more adhesive-backed stationery sheets 201, each contributing individual writes one or more messages 204 intended for the user on the provided sheets 201. The completed sheets with messages thereon 204 are then returned to the journal user, who adheres them 207 onto pages 203 within the journal 200. In a preferred embodiment, these messages 204 can range from well wishes and personal notes to guidance, support, teaching, reflections, advice, wisdom, prayers, drawings or any content that they wish to share with the journal user, and the journal user may write their own thoughts in adjacent pages 203 within the journal 200 as well. This method allows for a diverse range of inputs, capturing different voices and perspectives, and enriching the journal 200 with a multitude of insights and emotions. FIG. 3 is a flowchart illustrating the flow of messages between the individual contributors and a single journal user.

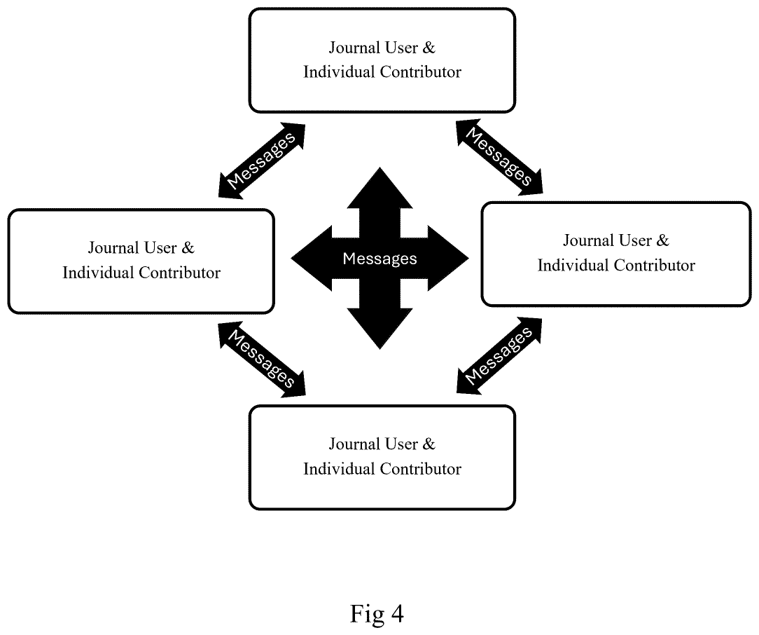

In another preferred embodiment, a group comprised of a plurality of individuals is provided with a bound journal book 200 for each member of the group and a plurality of adhesive-backed stationery sheets 201 for each member of the group, providing a reciprocal collaborative journaling experience. In this embodiment, each participant not only maintains a personal journal 200 of collected messages 204 but also contributes to the journals of the other members. This enables each member to have a record of messages 204 received and messages 204 written, forming a collective archive of shared experiences and personal reflections. FIG. 4 is a flowchart illustrating the flow of messages between the Individual Contributors and multiple Journal Users in a group setting.

In the preferred embodiments, once the adhesive-backed stationery sheets 204 are applied 207 to the pages 203 of the journal book 200, each sheet and its message become a permanent part of the user's journal, thereby preserving the contributors' words as part of a lasting keepsake. This method creates a personalized, tangible record that holds sentimental value for the user, allowing them to look back on personal notes from contributors.

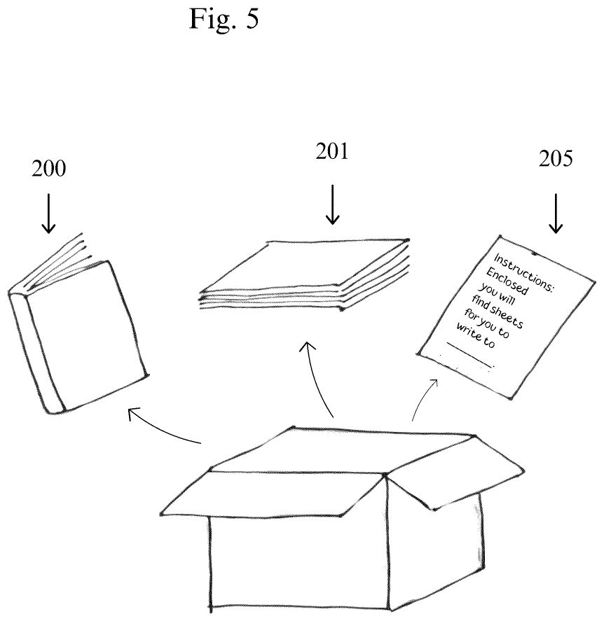

In a preferred embodiment, a fellowship journal kit is provided, which provides all necessary components for creating a personalized journal for a single journal user. FIG. 5 is an illustration of the contents of the kit. In a preferred embodiment, the kit includes at least a bound journal book 200, a plurality of adhesive-backed stationery sheets 201, 204 of the proper size for the journal, and instructions 205 for the user, detailing the methods for inviting contributions, affixing the sheets, and creating and maintaining the fellowship journal. FIG. 5 is an illustration of the contents of the kit preferred. This kit allows the user to easily follow the steps for maintaining a fellowship journal 200, supporting the simple yet meaningful process of gathering messages 204 and permanently preserving them.

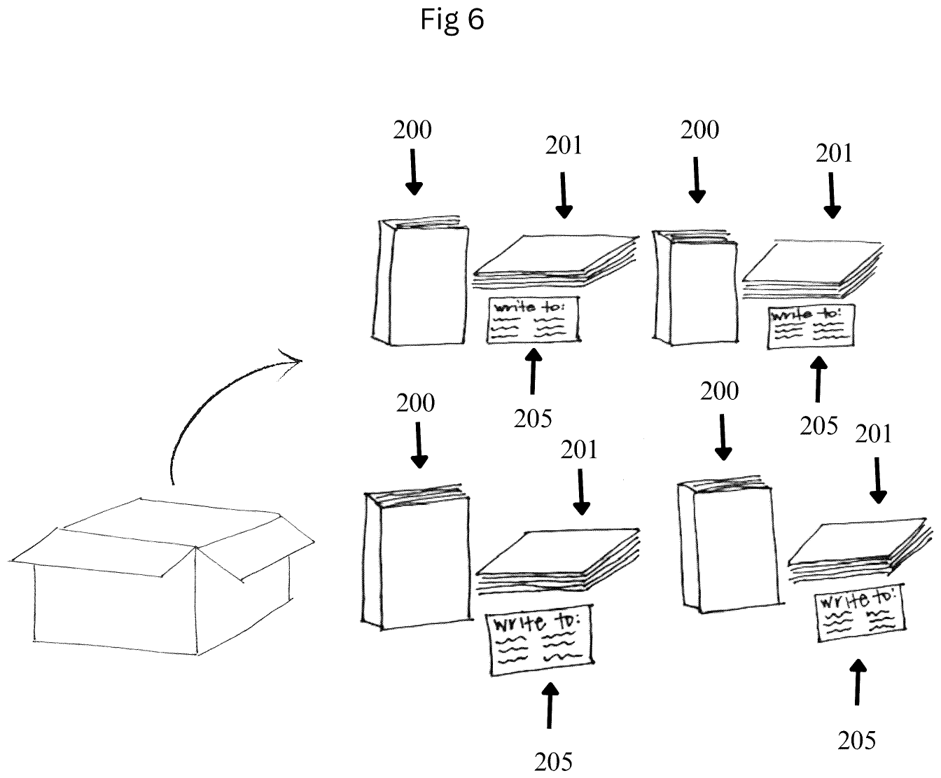

An additional preferred embodiment offers a group fellowship journal kit. Each member of the group maintains their own fellowship journal 200 while also contributing messages 204 to others within the group. The group kit includes a quantity of bound journal books 200 sufficient to provide one for each individual in the group, a sufficient quantity of adhesive-backed stationery sheets 201 to support message sharing among all group members, and multiple sets of instructions 205, ensuring that each group member can follow the process for creating and preserving their own fellowship journal 200. FIG. 6 is an illustration of the contents of the preferred embodiment of the group kit.

This group kit facilitates a collaborative journaling experience. Each participant not only maintains a personal journal 200 of collected messages 204 but also contributes to the journals of the other members. This enables each member to have a record of messages received and messages given, forming a collective archive of shared experiences and personal reflections.

1. A physical-media-based system comprising a bound journal book of a plurality of pages and a plurality of sheets of adhesive-backed stationery on which messages may be recorded, wherein the adhesive-backed stationery is sized to fit within the area of the pages of the journal such that the adhesive-backed stationery may be adhered to any given page within the journal, fitting completely within the bounds of said page, and once adhered, the adhesive-backed stationery sheet and any message recorded thereon become a permanent part of the bound journal book.

2. Using the system recited in claim 1, a method for creating and maintaining a fellowship journal wherein the bound journal book is provided to an individual user, one or more of the adhesive-backed stationery sheets are provided to one or more contributing person(s), the contributing person(s) write messages to the user on the adhesive-backed stationery sheets, the adhesive-backed stationery sheets with messages are delivered to the user, and the user then adheres the adhesive-backed stationery sheets into the bound journal book, making the messages from the contributing person or persons a permanent part of the user's journal.

3. A kit containing the items necessary to create and maintain a fellowship journal using the method recited in claim 2, comprised of the bound journal book, a plurality of the adhesive-backed stationery sheets, and instructions to the purchaser or recipient of the kit explaining how to employ the method recited in claim 2 to create and maintain a fellowship journal.

4. A kit as described in claim 3 which contains a plurality of the bound journal books, a plurality of the adhesive-backed stationery sheets, and a plurality of sets of the instructions, providing for each individual in a group comprised of a plurality of members to maintain their own fellowship journal as the user, while also serving as a contributing person to the journals of the other members of the group, such that all members of the group may both write and receive messages to be placed in their respective journals.
